(19) United States
(12) Patent Application Publication
(10) Pub. No.: US 2025/0147920 A1
(43) Pub. Date: May 8, 2025

(54) COMPUTING SYSTEM INCLUDING MULTI-CORE PROCESSOR AND OPERATING METHOD THEREOF

(71) Applicant: Samsung Electronics Co., Ltd., Suwon-si (KR)

(72) Inventors: Moongyung KIM, Suwon-si (KR); Euiyeon WON, Suwon-si (KR); Donghyeon HAM, Suwon-si (KR); Youngsik EOM, Suwon-si (KR); Ara CHO, Suwon-si (KR)

(73) Assignee: Samsung Electronics Co., Ltd., Suwon-si (KR)

(21) Appl. No.: 18/756,924

(22) Filed: Jun. 27, 2024

(30) Foreign Application Priority Data
Nov. 8, 2023 (KR) 10-2023-0153674

(51) Int. Cl. G06F 15/80; G06F 9/48

(52) U.S. Cl. CPC G06F 15/80; G06F 9/4856

(57) ABSTRACT

A multi-core processor according to some example embodiments may be a multi-core processor including a plurality of cores, and may include a first core that receives a task migration instruction, and transmits metadata including branch prediction data obtained during execution of a migration subject task determined as a subject of the task migration instruction among a plurality of tasks, to an external memory, and a second core that receives a task execution instruction, and reads the metadata from the external memory on the basis of the task execution instruction, and executes the migration subject task using the metadata.

### CROSS-REFERENCE TO RELATED APPLICATION

This application claims priority to and the benefit of Korean Patent Application No. 10-2023-0153674 filed in the Korean Intellectual Property Office on Nov. 8, 2023, the entire contents of which are incorporated herein by reference.

### BACKGROUND OF THE INVENTION

The present disclosure relates to computing systems including a multi-core processor and operating methods thereof.

An operating system (OS), which is executed in a computing system, manages all hardware resources and software resources in the computing system. To complete a series of tasks, the OS manages the processing order of the tasks and resources required for the tasks, and a processor such as a central processing unit (CPU) handles most of tasks which occur in the OS. Recently, as the performance of computing systems has been improved, computing systems including a plurality of processors or a plurality of core processors have been developed.

In a multi-core environment with multiple cores, parallelism capable of handling multiple tasks simultaneously may be implemented, whereby it is possible to expect a significant improvement in the performance as compared to single-core environments. However, a load imbalance may occur where more tasks were assigned to specific cores, which caused the system performance not to be improved proportionally to an increase in the number of cores and cause uneven wear. To solve this problem, a load balancing technique of migrating tasks from a core with a high load to another core with a relatively lower load to balance tasks that are assigned to individual cores is desired.

### SUMMARY OF THE INVENTION

The present disclosure provides computing systems including a multi-core processor for performing task migration accompanied by metadata, and operating methods thereof.

The present disclosure provides computing systems including a multi-core processor and operating methods thereof, capable of preventing or reducing initialization of metadata due to task migration and minimizing or reducing a degradation in the performance of cores due to initialization of metadata.

A multi-core processor according to some example embodiments may be a multi-core processor including a plurality of cores, and may include a first core configured to receive a task migration instruction, and transmit metadata including branch prediction data obtained during execution of a migration subject task determined as a subject of the task migration instruction among a plurality of tasks, to an external memory, and a second core that configured to receive a task execution instruction, and reads the metadata from the external memory on the basis of the task execution instruction, and execute the migration subject task using the metadata.

An operating method of a computing system according to some example embodiments may include determining a first core as a source core among a plurality of cores based on a utilization of the first core, determining a first task among a plurality of tasks assigned to the first core, as a migration subject task, converting metadata obtained during execution of the first task into conversion data based on conversion rules, and a step of transmitting the conversion data to a memory.

A multi-core processor according to some example embodiments may include a scheduler, and a first core that includes first metadata save logics configured to save first metadata obtained during execution of a first task that is a subject of a task migration instruction of the scheduler based on receiving the task migration instruction and transmit the first metadata to an external memory, and first metadata restore logics configured to receive second metadata to be used to execute a second task that is the subject of a task execution instruction of the scheduler, from the external memory based on receiving the task execution instruction, and restore the second metadata.

### BRIEF DESCRIPTION OF THE DRAWINGS

FIG. 1 is a schematic block diagram of a computing system according to some example embodiments.

FIG. 2 is a block diagram for explaining the operating method of a processor according to some example embodiments.

FIG. 3 is a block diagram for explaining the operating method of a processor according to some example embodiments.

FIG. 4 is a flow chart for explaining a task migration method according to some example embodiments.

FIG. 5 is a block diagram for explaining the task migration method according to some example embodiments.

FIG. 6 is a block diagram for explaining the operating method of a processor according to some example embodiments.

FIG. 7 is a drawing for explaining the operating method of a processor according to some example embodiments.

FIG. 8 is a drawing for explaining the operating method of a processor according to some example embodiments.

FIG. 9 is a drawing for explaining the operating method of the processor according to some example embodiments.

FIG. 10 is a drawing for explaining the operating method of the processor according to some example embodiments.

FIG. 11 is a drawing illustrating a system adopting a processor according to some example embodiments.

### DETAILED DESCRIPTION OF THE EMBODIMENTS

In the following detailed description, only certain example embodiments of the present inventions have been shown and described, simply by way of illustration. As those skilled in the art would realize, the described embodiments may be modified in various different ways, all without departing from the spirit or scope of the present inventions.

Accordingly, the drawings and description are to be regarded as illustrative in nature and not restrictive. Like reference numerals designate like elements throughout the specification. In the flow charts described with reference to the drawings, the order of operations may be changed, and several operations may be combined, and an operation may be divided, and some operations may not be performed.

Further, expressions written in the singular forms can be comprehended as the singular forms or plural forms unless clear expressions such as “a”, “an”, or “single” are used. Terms including an ordinal number, such as first and second, are used for describing various constituent elements, but the constituent elements are not limited by the terms. The terms are used only to discriminate one constituent element from other constituent elements.

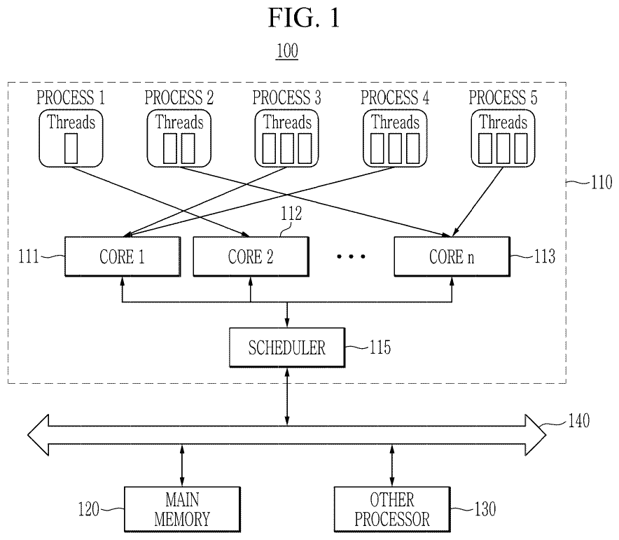

FIG. 1 is a schematic block diagram of a computing system according to some example embodiments.

Referring to FIG. 1, a computing system 100 according to some example embodiments may include a processor 110 including a plurality of cores 111, 112, and 113 and a scheduler 115, and a main memory (or a system memory) 120, and may further include an additional processor 130.

The processors 110 and 130 and the main memory 120 may perform communication with one another through a bus 140. In other words, the bus 140 may serve as an interface that supports communication between constituent elements.

The computing system 100 may be disposed and operate in an electronic device. The electronic device may be implemented in the form of a personal computer (PC), a data server, a laptop computer, an automotive electric component, or a portable device. The portable device may be implemented in the form of a mobile phone, a smart phone, a tablet PC, a wearable device, a personal digital assistant (PDA), an enterprise digital assistant (EDA), an image processing device with an image sensor, a digital still camera, a digital video camera, a portable multimedia player (PMP), a personal navigation device or portable navigation device (PND), a handheld game console, or an e-book.

The processor 110 may be a main processor and control the overall operation of the computing system 100. The processor 110 may be a multi-core processor including the plurality of cores 111, 112, and 113. The processors 110 and 130 may be central processing units (CPUs), graphic processing units (GPUs), neural processing units (NPUs), or application cores (application processors (APs)). The processors 110 and 130 may be processors identical to or different from each other.

A plurality of processes PROCESS1 to PROCESS5 may be assigned to the processor 110. The plurality of processes PROCESS1 to PROCESS5 may be assigned to the plurality of cores 111, 112, and 113 in the processor 110. The plurality of cores 111, 112, and 113 may be identical to or different from one another.

The processes are objects that may be generally assigned to cores and are executed, and refer to running programs. One process may consist of multiple execution units. Hereinafter, execution units will be referred to as threads.

Like a process, each thread is a flow of control that can independently execute objects in a process that are basic units using a processor or a core, for example, commands. Each thread shares codes, address spaces, files which are resources of the operating system, signals, and so on with the other threads included in the same group, and such a thread group may be referred to as a process. In other words, one process may include one or more threads.

In some example embodiments, the scheduler 115 may assign the plurality of processes PROCESS1 to PROCESS5 to the plurality of cores 111, 112, and 113. In some example embodiments, the scheduler 115 may determine the priorities of the processes, and select a core to execute a process, on the basis of the determined priorities. For example, the scheduler 115 may determine the priorities of the processes based on a predetermined (or, alternatively, desired, determined, or selected) priority determination scheme. The scheduler 115 may consider the states of the cores (e.g., utilization, performance, etc.) when assigning the processes to the cores on the basis of the determined priorities.

As described above, in multi-core systems, as a load imbalance occurs or a phenomenon occurs in which power consumption is concentrated in specific or individual cores, it is required (or, for example, beneficial or useful) to migrate tasks from one core to other cores. This task migration may refer to process migration or thread migration in which threads included in a process are migrated.

In some example embodiments, the scheduler 115 may determine whether to migrate tasks from one core to another core, in consideration of the utilization of each of the cores. For example, the scheduler 115 may determine whether the utilization of each of the cores exceeds a utilization threshold. In this case, when it is determined that the utilization of a specific core (for example, utilization of core 111) exceeds the utilization threshold, the scheduler 115 may determine to migrate a process or a thread that is executed in the corresponding core (for example, the core 111) to another core (for example, core 112).

In some example embodiments, the scheduler 115 may select a core to execute the process or the thread which is the subject of migration. The scheduler 115 may consider the utilization of each of the cores 111, 112, and 113 when selecting a core to execute a task. For example, the utilization of a core to execute a task may be lower than the utilization of a core from which the task is migrated.

Task migration may be accompanied by migration of data required (or, for example, beneficial or useful) to execute tasks. Among the plurality of cores 111, 112, and 113, a core whose task has been determined to be migrated by the scheduler 115 may transmit data obtained by executing the corresponding task together. In some example embodiments, when migration of a task from a first core (hereinafter, referred to as a “source core”) to a second core (hereinafter, referred to as a “target core”) is determined by the scheduler 115, the source core may transmit data obtained by executing the corresponding task to the main memory 120, and the main memory 120 may store the data received from the source core. Thereafter, the target core may restore the data stored in the main memory 120 into the target core to execute the task migrated from the source core. The target core may restore the data received from the main memory 120, and use the restored data to execute the task.

In some example embodiments, the data which the source core obtained by executing the task may contain values that are stored in a program counter, a stack pointer, a general purpose register, and the like.

In some example embodiments, the data which the source core obtained by executing the task may further contain metadata. The metadata may contain a branch prediction history, translation lookaside buffer (TLB) data, prefetch data, power control data, etc. In other words, the metadata may be information related to the performance or power consumption of the core accumulated during the execution of the task. In some example embodiments, the target core may restore the metadata required (or, for example, beneficial or useful) to execute the task, from the main memory 120, thereby capable of preventing or reducing re-execution of branch prediction, prefetching, and the like when the task is executed in the target core. This has the advantage of preventing or reducing metadata initialization due to the task migration and minimizing or reducing a degradation in the core performance due to metadata initialization.

In some example embodiments, the main memory 120 may be a volatile memory such as a dynamic random access memory (DRAM) and/or a non-volatile memory such as a flash memory. For example, the main memory 120 may be configured with DRAMs, phase-change random access memories (PRAMs), magnetic random access memories (MRAMs), resistive random access memories (ReRAMs), ferroelectric random access memories (FRAMs), spin transfer torque RAMs (STT-RAMs), conductive bridging RAM (CBRAMs), NOR flash memories, NAND flash memories, vertical NAND (VNAND) flash memories, bonding vertical NAND (BVNAND) flash memories, fusion flash memories (for example, a memory in which static random access memory (SRAM) buffers, NAND flash memories, and NOR interface logics are combined), etc.

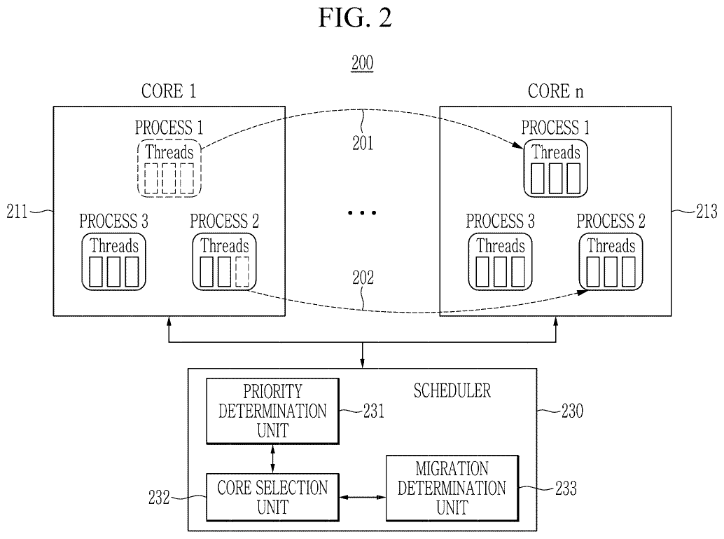

FIG. 2 is a block diagram for explaining the operating method of a processor according to some example embodiments. For example, FIG. 2 is a drawing for explaining task migration between a plurality of cores 211 and 213 in a processor 200 and the operating method of a scheduler 230 related thereto.

As described above in detail, as a plurality of cores executes a plurality of processes in parallel, a load imbalance between the plurality of cores may be caused. For example, when the first core 211 is assigned a process excessive as compared to the capacity of the core, the scheduler 230 may distribute some of tasks assigned to the first core 211 to other cores. In this way, the scheduler 230 may balance tasks that are assigned to the individual cores. Alternatively, when the tasks assigned to the first core 211 consume so much power that the differences in power consumption from other cores in the processor are too great, the scheduler may distribute some of the tasks assigned to the first core 211 to other cores, thereby balancing tasks that are assigned to the individual cores.

In some example embodiments, the scheduler 230 may assign tasks to the individual cores, and determine task migration for balancing tasks that are assigned to the individual cores. Hereinafter, the operating method of the scheduler 230 will be described in detail.

The scheduler 230 may include a priority determination unit 231, a core selection unit 232, and a migration determination unit 233.

In some example embodiments, the priority determination unit 231 of the scheduler 230 may determine the priorities of a plurality of processes and threads to be executed in the individual cores 211 and 213. The priority determination unit 231 may determine the priorities of the plurality of processes and threads in a predetermined (or, alternatively, desired, determined, or selected) priority determination scheme.

In some example embodiments, when the primary of a task is determined by the priority determination unit 231, the core selection unit 232 of the scheduler 230 may select a core to execute the corresponding task. The core selection unit 232 may consider the states of the cores (e.g., utilization, performance, etc.) when assigning tasks to the cores on the basis of the determined priorities. When a core to execute a task is determined by the core selection unit 232, the task may be assigned to the corresponding core.

In some example embodiments, the scheduler 230 may include the migration determination unit 233. The migration determination unit 233 may detect the utilization of the plurality of cores included in the processor 200, and determine whether the utilization of a specific core (for example, one of the plurality of cores) exceeds a utilization threshold. For example, the migration determination unit 233 may determine whether tasks assigned to the specific core generate a relatively high load as compared to tasks assigned to other cores, whether the specific core consumes excessive power as compared to other cores, and/or the like. When determining that the utilization of a specific core, for example, a source core (for example, the source core may be core 211) exceeds the utilization threshold, the migration determination unit 233 may determine process migration 201 or thread migration 202, for example, task migration in which tasks assigned to the source core 211 are migrated to other cores.

In some example embodiments, when task migration (arrows 201 and/or 202) is detected by the migration determination unit 233, the core selection unit 232 may determine a target core (for example, the target core may be core 213) to execute a corresponding task. The core selection unit 232 may consider the performance, utilization, and the like of the target core 213 when determining a target core (for example, the target core may be core 213). For example, the utilization of the target core (for example, the target core may be core 213) may be less than the utilization of the source core 211.

In some example embodiments, when the scheduler 230 determines task migration (arrows 201 and/or 202) and determines a target core (for example, the target core may be core 213) to execute the task that is the subject of migration, task migration from the source core 211 to the target core 213 may be performed. In some example embodiments, tasks may not be directly migrated from a core to another core, and are enqueued to a task queue which assigns tasks to cores, for example, a task queue that may include or not include the source core from which the task is migrated.

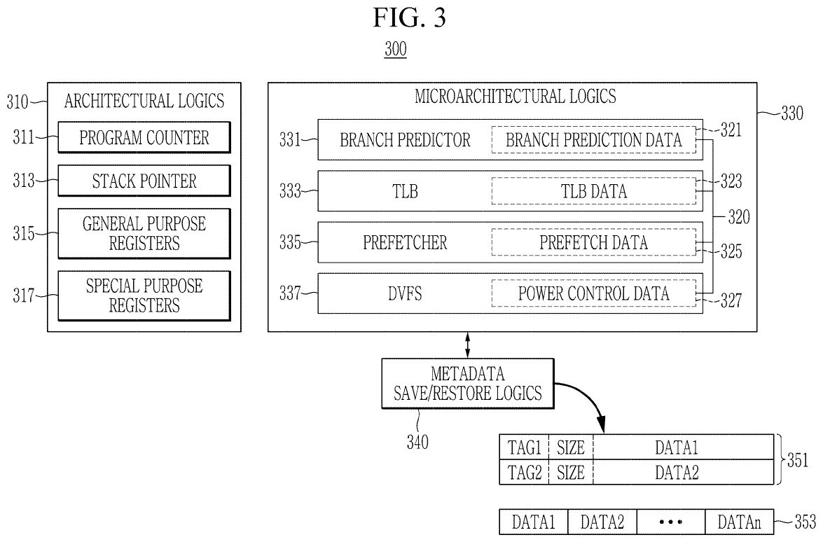

In some example embodiments, the task migration from the source core 211 to the target core 213 may be accompanied by migration of data required (or, for example, beneficial or useful) to execute the task. Data migration which goes with task migration will be described with reference to FIG. 3.

FIG. 3 is a block diagram for explaining the operating method of a processor according to some example embodiments. For example, FIG. 3 is a drawing for explaining data which is transmitted together during task migration from a source core to a target core. Here, it is assumed that a source core and a target core are the same type of cores.

In some example embodiments, a core 300 may include architectural logics 310, microarchitectural logics 330, and metadata save/restore logics 340.

In some example embodiments, the architectural logics 310 may include a program counter 311, a stack pointer 313, a general purpose register 315, and a special purpose register 317. When a task running on the core 300 is stopped from being executed by an arbitrary command, the architectural logics 310 may store minimum information that is required (or, for example, beneficial or useful) before the core 300 is powered off or the execution of the task is stopped. Accordingly, when power is reapplied to the core 300 or the execution of the task is resumed, the information stored in the architectural logics 310 may be used to restart the task from the point at which the execution of the task was stopped.

The program counter 311 is a register that stores data indicating the locations of commands that the task needs to execute. The commands assigned to the task may not be consecutively executed for reasons such as task migration, so it is required (or, for example, beneficial or useful) to record which command was last executed by the task. Accordingly, the program counter 311 may store data indicating commands that have been executed by the task, for example, which command was last executed by the task.

The stack pointer 313 may refer to a register that stores the location of a stack. Stacks are memory spaces that are used to store factors that are transmitted when functions are called, return addresses, variables that are declared in functions, and the like, and each task may have its own stack for an independent function call.

In addition, a variety of information that are used to execute the task may be stored in the general purpose register 315 or the special purpose register 317, and the data that are stored in the architectural logics 310 during task migration may be transmitted to the target core.

In some example embodiments, the core 300 may include the metadata save/restore logics 340 that stores and restores metadata 320. The metadata 320 may refer to a set of data that is, for example, information not required (or, for example, beneficial or useful) to be saved before the core 300 is powered off or the task running on the core 300 is stopped from being executed when the task is stopped by an arbitrary command, information less important to completing the task, or the like, and may be information required, important or relevant to be stored in order to improve the processing performance of the core 300 when the execution of the task is resumed or accessed. The metadata 320 may be generated by the microarchitectural logics 330. For example, the metadata 320 may contain branch prediction data 321, TLB data 323, prefetch data 325, and/or power control data 327.

The branch prediction data 321 may be generated by a branch predictor 331. The branch predictor 331 may predict the direction of a branch instruction (for example, whether the branch instruction will be taken or will not be taken) and a branch target address before the branch instruction reaches an execution stage in the pipeline. The branch prediction data 321 may contain a branch hit/miss history, a return stack, and a branch target address obtained from a branch target buffer (BTB), and the like, as the history of execution of a specific branch or all branches during execution of the task.

The TLB data 323 may be generated by a TLB 333

The TLB 333 may be a cache for improving the speed at which virtual memory addresses are translated into physical addresses, and contain a table for translation between virtual memory addresses and physical addresses which is used when the task is executed, and the like.

The prefetch data 325 may be generated by a prefetcher 335. When the core 300 executes a task such as an arithmetic or logic function, the prefetcher 335 may improve the performance of the core 300 by predicting commands or data to be computed by the core 300 and executing prefetching to load the commands or the data from a slower memory (for example, a memory in which an access time and/or a cycle time that is generally measured as a core cycle is longer) into a faster memory. The prefetch data 325 may contain prefetch training information, prefetch stride information, and the like obtained during the execution of the task.

The power control data 327 may be generated by a dynamic voltage and frequency scaling (DVFS) module 337. The DVFS technique is a technique capable of reducing the power consumption of the core 300 by dynamically adjusting the operating frequency and the operating voltage, and the power control data 327 may contain the operating voltage and operating frequency information of the core 300 and the like set by the DVFS module 337 when the core 300 executed a task of processing commands or data.

In some example embodiments, the metadata save/restore logics 340 may store metadata to be transmitted together during task migration when the core 300 is a source core, or restore metadata required (or, for example, beneficial or useful) to execute a task when the core 300 is a target core.

In some example embodiments, when migration of a task from the core 300 to another core is determined, for example, when the core 300 is determined as a source core, the core 300 may transmit data obtained by executing the task which is the subject of migration to the other core, for example, the target core. The data which the core 300 obtained by executing the task that is the subject of migration may contain data stored in the architectural logics 310 and the metadata 320. The metadata 320 may be loaded into the metadata save/restore logics 340. The metadata stored in the metadata save/restore logics 340 may be transmitted to the target core, along with or separately from the data stored in the architectural logics 310.

In some example embodiments, when migration of a task from another core to the core 300 is determined, for example when the core 300 is a target core, the core 300 may receive data required (or, for example, beneficial or useful) to execute the task, from the source core. The metadata of the data required (or, for example, beneficial or useful) to execute the task may be stored in the metadata save/restore logics 340. When the task which is the subject of migration is executed in the core 300, the data stored in the metadata save/restore logics 340 may be used.

In some example embodiments, the metadata 320 generated by the microarchitectural logics 330 may be stored in a form 351 with tags TAG in the metadata save/restore logics 340. For example, the metadata may contain tags TAG1 and TAG2 for identifying individual pieces of metadata, and data DATA1 and DATA2. The target core may distinguish metadata on the basis of the tags TAG attached to the metadata. The metadata may further contain information on the size of the metadata.

In some example embodiments, the metadata 320 generated by the microarchitectural logics 330 may be stored in a form 353 having a predetermined (or, alternatively, desired, determined, or selected) size in the metadata save/restore logics 340. For example, each piece of metadata required (or, for example, beneficial or useful) to execute the task may be assigned a predetermined (or, alternatively, desired, determined, or selected) size to store data, and be stored in the predetermined (or, alternatively, desired, determined, or selected) size in the metadata save/restore logics. The target core may distinguish the metadata on the basis of the predetermined (or, alternatively, desired, determined, or selected) size information of the metadata.

As described above, the metadata that is stored in the metadata save/restore logics of the source core may have a predetermined (or, alternatively, desired, determined, or selected) format. Accordingly, there is an advantage that the target core can easily identify the metadata that is received from the source core and use the metadata to execute the task.

For example, according to some example embodiments, there may be an increase in speed, accuracy, and/or power efficiency of the cores of a multicore processor based on the above methods. Therefore, the improved devices and methods overcome the deficiencies of the conventional devices and methods of multicore processors related to including usage of multicore processor devices while reducing resource consumption, data accuracy, and increasing data clarity. Further, there is an improvement in communication and reliability in the multicore processors by providing the abilities disclosed herein, for example, related to metadata sharing.

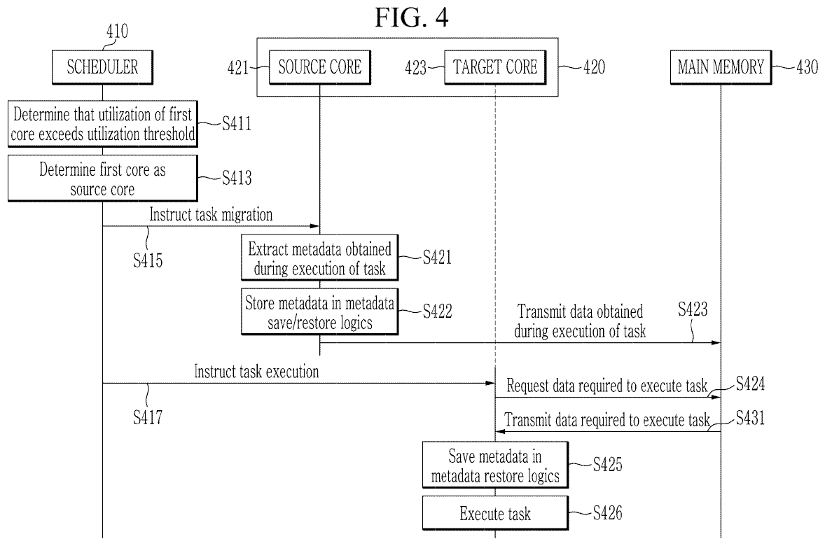

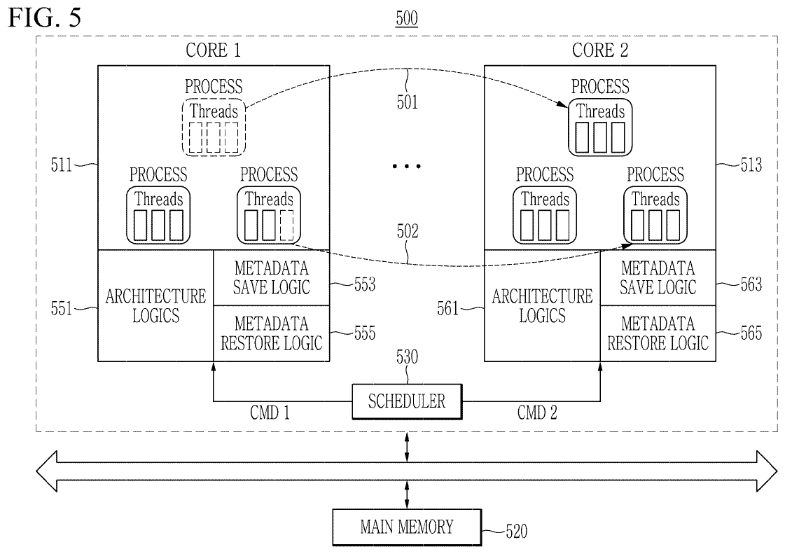

FIG. 4 is a flow chart for explaining a task migration method according to some example embodiments, and FIG. 5 is a block diagram for explaining the task migration method according to some example embodiments. The flow chart of FIG. 4 will be described with reference to FIG. 5 together.

In some example embodiments, a scheduler 410 may assign processes to cores in a multi-core system. The scheduler 410 may determine the priorities of the processes in a predetermined (or, alternatively, desired, determined, or selected) priority determination scheme, and selects a core to execute each process. When selecting a core, the scheduler 410 may consider, for example, the performance of the cores and the like.

In some example embodiments, the scheduler 410 may detect the utilization of a plurality of cores 420, and determine cores whose utilization executes a utilization threshold from among the plurality of cores 420 (S411). For example, the scheduler 410 may determine that the utilization of a first core of the plurality of cores exceeds the utilization threshold (S413). The scheduler 410 may determine whether the utilization of the first core exceeds the utilization threshold, on the basis of the capacity, power consumption, and the like of the first core.

In some example embodiments, when it is determined that the utilization of the first core exceeds the utilization threshold, the scheduler 410 may determine the first core as a source core 421. The scheduler 410 may determine the first core as the source core 421 such that some of the tasks assigned to the first core whose utilization exceeds the utilization threshold can be migrated to other cores (for example, some of the tasks can be assigned to other cores). Referring to FIG. 5 together, a scheduler 530 may determine a first core 511 as a source core on the basis of the utilization of cores, and determine process migration 501 or thread migration 502, for example, task migration related to a task running on the first core 511.

In some example embodiments, the scheduler 410 may instruct the source core 421 to execute task migration (S415). The scheduler 410 may migrate some of the tasks assigned to the first core determined as the source core 421 to other cores. Referring to FIG. 5 together, the scheduler 530 may transmit a first command CMD1 for instructing task migration related to a task running on the first core 511. In other words, the task assignment for instructing the task migration may be enqueued to the task queue of the first core 511. The first command CMD1 may contain a task ID for identifying the task which is the subject of migration, and metadata information to be extracted to be transmitted to the target core to execute task which is the subject of migration through a main memory 520.

In some example embodiments, the source core 421 may extract the metadata obtained during the execution of the task (S421), and store the extracted metadata in the metadata save/restore logics (S422). Referring to FIG. 5 together, the first core 511 which is the source core may include architectural logics 551, metadata save logics 553, and metadata restore logics 555. When the first core 511 receives the first command CMD1 from the scheduler 530, it may extract the metadata to be transmitted to the main memory 520, on the basis of the first command CMD1. The extracted metadata may be all or some of the metadata obtained in the first core 511 during the execution of the task which is the subject of migration. The first core 511 may store the extracted metadata in the metadata save logics 553. The metadata stored in the metadata save logics 553 may be stored in a form with tags or in a predetermined (or, alternatively, desired, determined, or selected) size.

In some example embodiments, the source core 421 may transmit the data obtained during the execution of the task to a main memory 430 (S423). Referring to FIG. 5 together, the first core 511 may transmit the metadata obtained during the execution of the task which is the subject of migration and stored in the metadata save logics 553 to the main memory 520. The data obtained during the execution of the task may contain data stored in the architectural logics 551 and data stored in the metadata save logics 553.

In some example embodiments, the scheduler 410 may determine a target core 423, and instructs the target core 423 to execute the task (S417). Referring to FIG. 5 together, the scheduler 530 may determine a second core 513 as the target core. The scheduler 530 may determine the target core in consideration of the performance, utilization, power consumption, and the like of cores. The scheduler 530 may transmit a second command CMD2 for instructing task execution. In other words, the task assignment for instructing the task execution may be enqueued to the task queue of the second core 513. The second command CMD2 may contain a task ID for identifying the task which is the subject of migration, and metadata information to be used to execute the task which is the subject of migration.

In some example embodiments, the target core 423 may request data required (or, for example, beneficial or useful) to execute the task which is the subject of migration, from the main memory 430 (S424), and the main memory 430 may transmit the data required (or, for example, beneficial or useful) to execute the task which is the subject of migration, on the basis of the request of the target core 423 (S431). Referring to FIG. 5 together, when the second core 513 which is the target core receives the second command CMD2 of the scheduler 530, it may request data required (or, for example, beneficial or useful) for task execution from the main memory 520 on the basis of the second command CMD2. The data required (or, for example, beneficial or useful) for task execution may refer to metadata contained, as data to be used to execute the task, in the second command CMD2. For example, the second core 513 may identify metadata to be used to execute the task, on the basis of tag information attached to metadata among the data stored in the main memory 520. The data required (or, for example, beneficial or useful) to execute the task may contain data transmitted from the architectural logics 551 and metadata save logics 553 of the first core 511 which is the source core to the main memory 520. The main memory 520 may transmit the data required (or, for example, beneficial or useful) to execute the task, on the basis of the request of the second core 513. The second core 513 may read the metadata stored in the main memory 520.

In some example embodiments, the target core 423 may store the metadata received from the main memory 430 in metadata restore logics (S425). Referring to FIG. 5 together, the second core 513 which is the target core may contain architectural logics 561, metadata save logics 563, and metadata restore logics 565. The data received from the main memory 520 may be stored in the architectural logics 561 and metadata restore logics 565 of the second core 513. The metadata of the data received from the main memory 520 may be stored in the metadata restore logics 565.

In some example embodiments, the target core 423 may execute the task (S426). Referring to FIG. 5 together, the second core 513 may use the data stored in the architectural logics 561 and the metadata restore logics 565 to execute the task which is the subject of the task migration (arrows 501 and/or 502). When resuming the task which is the subject of the task migration, the second core 513 may restart from the point at which the task was stopped from being executed, using the data saved in the architectural logics 561, and can prevent or reduce metadata initialization due to task migration by using the metadata in the metadata restore logics 565 and minimize or reduce a degradation in the core performance due to metadata initialization.

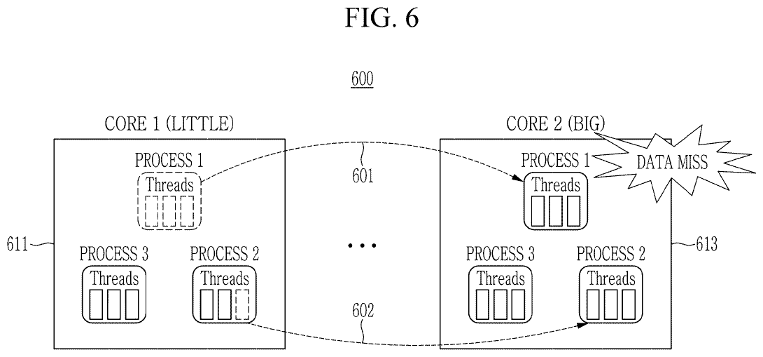

FIG. 6 is a block diagram for explaining the operating method of a processor according to some example embodiments. For example, FIG. 6 is a drawing for explaining task migration between cores when a source core and a target core in a processor are different types of cores.

In some example embodiments, a processor 600 may include a first core 611 and a second core 613. In some example embodiments, the first core 611 may be a low-power little core, and the second core may be a high-performance big core. Accordingly, the amount of computation which is executed in the first core 611 per unit time may be smaller than the amount of computation of the second core 613 per unit time. In some example embodiments, the processor 600 may further include at least one third core (not shown in the drawing) distinguished from the first core 611 and the second core 613.

In some example embodiments, a load imbalance may occur between the first core 611 and the second core 613. For example, the amount of power which the first core 611 consumes to execute assigned tasks may be (for example, excessively, or greater than an energy difference threshold) larger as compared to the second core 613, or the utilization of the first core 611 may be (for example, excessively) higher as compared to the second core 613. Or, for example, the utilization of the first core 611 may exceed a utilization threshold. In this case, a scheduler in the processor 600 may try to migrate some of the tasks from the first core 611 to the second core 613. In other words, the scheduler in the processor 600 may determine process migration 601 or thread migration 602, for example, task migration from the first core 611 to the second core 613. When task migration is determined, data required (or, for example, beneficial or useful) for the task migration may be transmitted together. However, since the first core 611 and the second core 613 are different types of cores, metadata required (or, for example, beneficial or useful) for the task migration may not be compatible. In this case, even if the metadata is extracted from the first core 611, the metadata cannot be used in the second core 613. Accordingly, during task execution in the second core 613, a degradation in the core performance due to metadata initialization may be caused. For this reason, in order to maintain the compatibility of the metadata, it is required (or, for example, beneficial or useful) for the source core to convert and store the metadata according to a predetermined (or, alternatively, desired, determined, or selected) format, and for the target core to reconvert the converted data into data usable in the core according to a predetermined (or, alternatively, desired, determined, or selected) format.

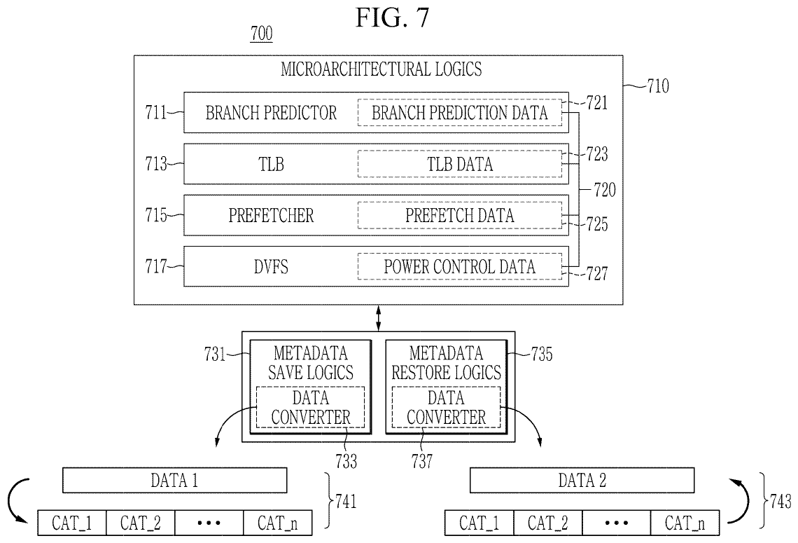

FIG. 7 is a drawing for explaining the operating method of a processor according to some example embodiments. For example, FIG. 7 is a drawing for explaining a method for maintaining the compatibility of metadata which is transmitted together during migration of a task between different types of cores.

In some example embodiments, a core 700 may include microarchitectural logics 710. The microarchitectural logics 710 may include a branch predictor 711 that generates branch prediction data 721, a TLB 713 that generates TLB data 723, a prefetcher 715 that generates prefetch data 725, and a DVFS module 717 that generates power control data 727. The branch prediction data 721, the TLB data 723, the prefetch data 725, and the power control data 727 may be referred to as metadata 720. With respect to the metadata 720, a description that is redundant to the description related to FIG. 3 will not be made.

In some example embodiments, there may be a problem that the compatibility of metadata is not maintained when task migration between different types of cores is executed. A specific example in which metadata is not compatible during task migration is as follows.

For example, when task migration from a source core to a target core is determined, the source core may transmit hit/miss information related to a specific virtual address VA obtained from a branch predictor which is one of the microarchitectural logics, to the target core. However, the branch predictor in the source core may manage hit/miss information related to a specific virtual address VA in four levels: a strong-hit level, a weak-hit level, a weak-miss level, and a strong-miss level, and a branch predictor in the target core may manage hit/miss information related to a specific virtual address VA in two levels: a hit level and a miss level. In this case, when the branch prediction data is transmitted from the source core to the target core, from the data of the source core, the target core cannot interpret which part indicates the virtual address, what the strong/weak hit/miss information of the source core means, and the like. Here, the example of branch prediction data has been described; however, between different types of cores, the problem in which not only branch prediction data but also metadata such as prefetch data are not compatible may occur variously.

In order to solve the above-mentioned problem, each piece of metadata may be converted into a predetermined (or, alternatively, desired, determined, or selected) form that can be interpreted in the target core. For example, the data compatibility between cores where task migration is executed may be maintained by categorizing metadata and converting the information stored in each category according to predetermined (or, alternatively, desired, determined, or selected) rules. For example, when the branch predictor in the source core manages hit/miss information related to a specific virtual address VA in four levels: a strong-hit level, a weak-hit level, a weak-miss level, and a strong-miss level, and the branch predictor in the target core manages hit/miss information related to a specific virtual address VA in two levels: a hit level and a miss level, the source core may convert branch prediction data by classifying the virtual address VA and hit/miss information of branch prediction data in a category and assigning specific bits to hit information and miss information in the category containing the hit/miss information, such that the target core can interpret the virtual address VA, the hit information, and the miss information. Accordingly, metadata save logics 731 in the core may include a data converter 733 that converts metadata according to predetermined (or, alternatively, desired, determined, or selected) conversion rules, and metadata restore logics 735 may include a data converter 737 that interprets the converted metadata and reconverts the converted metadata into a format usable in the target core according to predetermined (or, alternatively, desired, determined, or selected) conversion rules.

In some example embodiments, when the core 700 is determined as the source core, for example, when the core receives a task migration instruction, all or some of the metadata 720 may be stored in the metadata save logics 731 on the basis of the task migration instruction. The data converter 733 in the metadata save logics 731 may convert the metadata according to predefined conversion rules (for example, operation 741). The metadata may be converted into a form interpretable in the target core by the data converter 733 in the metadata save logics 731.

In some example embodiments, when the core 700 is determined as the target core, for example, when the core receives a task execution instruction, the metadata restore logics 735 may receive metadata from the outside. The metadata stored in the metadata restore logics 735 may be data converted according to predefined conversion rules. The data converter 737 in the metadata restore logics 735 may interpret the data stored in the metadata restore logics 735 and reconvert the data into data usable in the core 700 (for example, operation 743). The core 700 may use the data converted by the data converter 737 to execute the task which is the subject of migration.

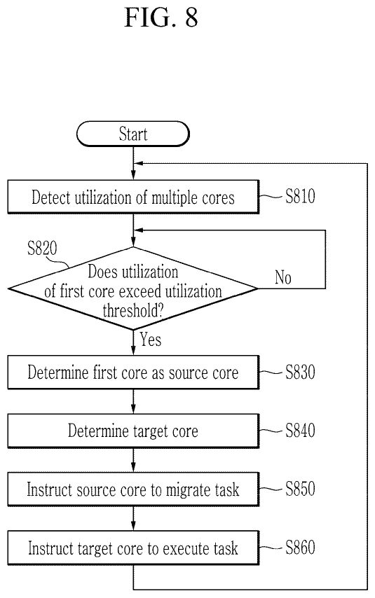

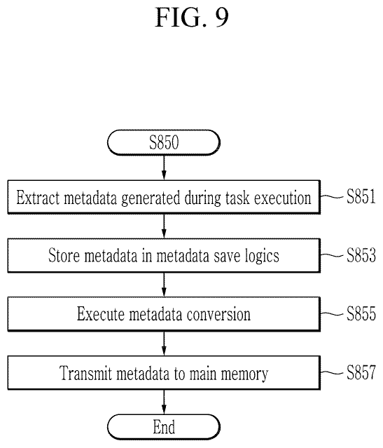

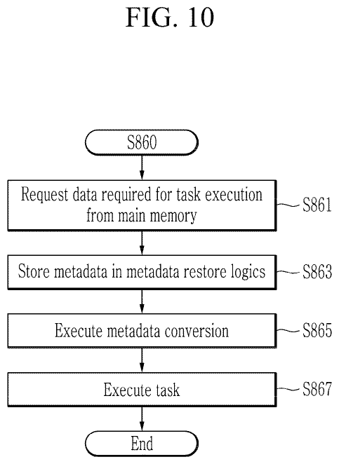

FIG. 8 to FIG. 10 are drawings for explaining the operating method of a processor according to some example embodiments. For example, FIG. 8 shows an operating method of a scheduler in a processor, and FIG. 9 and FIG. 10 are flow charts for explaining operating methods of a source core and a target core when the source core and the target core are different types of cores.

In some example embodiments, a scheduler in a system may assign a plurality of tasks to a plurality of cores, and detect the utilization of the plurality of cores (S810).

In some example embodiments, the scheduler may determine whether the utilization of a first core of the plurality of cores exceeds a utilization threshold (S820). The case where the utilization of the first core exceeds the utilization threshold may include the case where it is determined that the amount of power that tasks assigned to the first core is too large in a low-power environment and thus the differences in power consumption from other cores in the system are excessively large or the tasks assigned to the first core cause a relatively high load as compared to tasks assigned to other cores.

In some example embodiments, the scheduler may determine the first core of the plurality of cores as a source core when the utilization of the first core exceeds the utilization threshold (S830). In other words, the scheduler may determine some of the tasks running on the first core as tasks which are the subjects of migration.

In some example embodiments, the scheduler may determine a target core to execute a task that is the subject of migration, from the source core of the plurality of cores (S840). The scheduler may determine the target core in consideration of the performance, utilization, and the like of the target core. In some example embodiments, the utilization of the target core may be less than the utilization of the source core.

In some example embodiments, the scheduler may instruct the source core to migrate the task (S850). The scheduler may transmit a command to instruct the task migration, to the source core. In other words, task assignment for instructing the task migration may be enqueued to the task queue of the source core. The command to instruct the task migration may contain a task ID for identifying the task which is the subject of migration, and metadata information to be transmitted to the target core among the metadata obtained during the execution of the task.

In some example embodiments, the scheduler may instruct the target core to execute the task (S860). The scheduler may transmit a command to instruct the target core to execute the task which is the subject of migration. In other words, task assignment for instructing the task execution may be enqueued to the task queue of the target core. The command to instruct the task execution may contain a task ID for identifying the task which is the subject of migration, and metadata information to be used to execute the task which is the subject of migration.

FIG. 9 is a flow chart for explaining the operating method which the source core executes to migrate the task which is the subject of migration when the source core and the target core are different types of cores.

In some example embodiments, when the source core receives the task migration instruction from the scheduler (S850), the source core may extract metadata generated in the process of executing the task that is the subject of migration (S851). The source core may extract some or all of the metadata generated in the task execution process, on the basis of the task migration instruction of the scheduler.

In some example embodiments, the source core may store the extracted metadata in the metadata save logics (S853).

In some example embodiments, the source core may execute data conversion on the metadata stored in the metadata save logics (S855). In order to maintain the compatibility of the metadata between the source core and the target core, the data converter in the metadata save logics may convert the metadata according to the predefined conversion rules. In some example embodiments, the source core may transmit the converted data to the main memory (S857). Further, the source core may transmit the data in the architectural logics, generated in the task execution process, together to the main memory.

FIG. 10 is a flow chart for explaining the operating method which the target core executes in order to execute the task which is the subject of migration when the source core and the target core are different types of cores.

In some example embodiments, when the target core receives a task execution insulation for the task that is the subject of migration, from the scheduler (S860), the target core may request data required (or, for example, beneficial or useful) to execute the task that is the subject of migration, from the main memory (S861). The metadata that is received from the main memory may be data converted according to the predefined conversion rules. The target core may request the metadata to be used to execute the task that is the subject of migration, on the basis of the task execution instruction of the scheduler. The target core may read the metadata to be used to execute the task that is the subject of migration among the metadata stored in the main memory.

In some example embodiments, the target core may store the metadata received from the main memory in the metadata restore logics (S863).

In some example embodiments, the target core may execute data conversion on the metadata stored in the metadata restore logics (S865). The data converter in the metadata restore logics may interpret the metadata converted according to the predefined conversion rules and reconvert the metadata into a form usable in the target core according to the predetermined (or, alternatively, desired, determined, or selected) conversion rules.

In some example embodiments, the target core may execute the migration subject task migrated from the source core (S867).

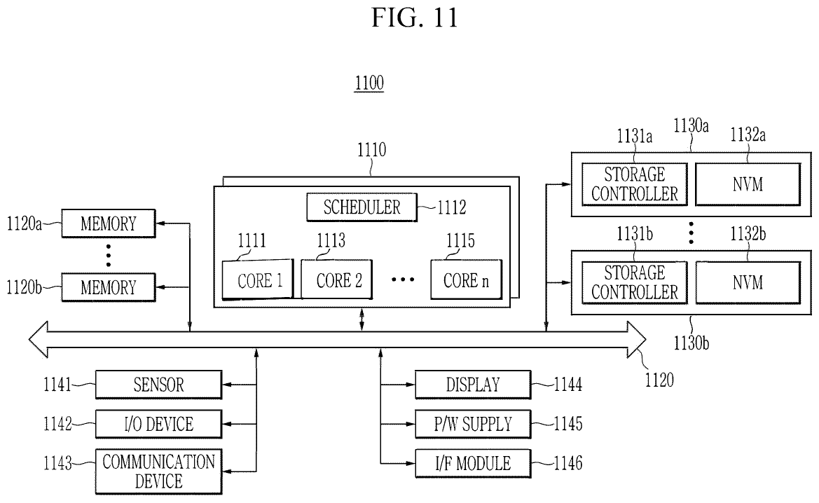

FIG. 11 is a drawing illustrating a system adopting a processor according to some example embodiments.

A system 1100 may include a main processor 1110, a bus 1120, memories 1120a and 1120b, and storage devices 1130a and 1130b, and may further include a sensor 1141, an input/output device (I/O device) 1142, a communication device 1143, a display 1144, a power supply (P/W supply) 1145, and an interface module (I/F module) 1146.

The system 1100 may include at least one processor 1110. The processor 1110 may be a processor according to some example embodiments described with reference to FIG. 1 to FIG. 10. The processor 1110 may control the overall operation of the system 1100, more specifically, the operations of other components constituting the system 1100. This processor 1110 may be implemented with a general-purpose processor, a dedicated processor, an application processor, or the like. The processor 1110 may be a CPU, a GPU, an NPU, or the like.

In some example embodiments, the processor 1110 may include a plurality of cores 1111, 1113, and 1115. The processor 1110 may include a scheduler 1112 that assigns processes to a plurality of cores and determines migration of an assigned process. In some example embodiments, the scheduler 1112 may detect the utilization of individual processors and determine process migration based on the detection result. The plurality of cores 1111, 1113, and 1115 according to some example embodiments may transmit data required (or, for example, beneficial or useful) to execute a process, during migration of the process. The data required (or, for example, beneficial or useful) for the process execution may contain metadata. The metadata may contain a branch prediction history, TLB data, prefetch data, power control data, etc. When the metadata required (or, for example, beneficial or useful) for the task execution is transmitted together, there is an advantage of preventing or reducing metadata initialization due to the task migration and minimizing or reducing a degradation in the core performance due to metadata initialization.

The memories 1120a and 1120b may be used as main memory devices of the system 1100. The memories 1120a and 1120b may store data that is migrated together during task migration in the processor 1110. The memories 1120a and 1120b may transmit the stored data in response to a request of the processor 1110. The memories 1120a and 1120b may include volatile memories such as SRAMs, DRAMs, or combinations thereof, but may also include non-volatile memories such as flash memories, PRAMs, RRAMs, or combinations thereof. The memories 1120a and 1120b may be implemented along with the main processor 1110 in the same package.

The storage devices 1130a and 1130b may include storage controllers 1131a and 1131b, and non-volatile memories (NVMs) 1132a and 1132b that store data under the control of the storage controllers 1131a and 1131b. The non-volatile memories 1132a and 1132b may include flash memories having a two-dimensional (2D) structure or a three-dimensional (3D) vertical NAND (V-NAND) structure, but may also include other types of non-volatile memories such as PRAMs and/or RRAMs.

The storage devices 1130a and 1130b may be included in the system 1100 so as to be physically separate from the processor 1110, or may be implemented along with the main processor 1110 in the same package. Further, the storage devices 1130a and 1130b may have a form such as a solid state device (SSD) or a memory card so as to be able to be removably coupled to other components of the system 1100 through interfaces such as the interface module 1146 to be described below. The storage devices 1130a and 1130b may be devices to which a standard protocol such as universal flash storage (UFS), embedded multi-media card (eMMC), or non-volatile memory express (NVMe) is applied, but are not limited thereto.

The sensor 1141 may detect various types of physical qualities that may be obtained from the outside of the system 1100, and convert the detected physical qualities into electrical signals. The sensor 1141 may be a temperature sensor, a pressure sensor, an illuminance sensor, a position sensor, an acceleration sensor, a biosensor, a gyroscope sensor, or a combination thereof.

The I/O device 1142 may receive various types of data input from a user of the system 1100, and may be a touch pad, a keypad, a keyboard, a mouse, a microphone, or a combination thereof.

The communication device 1143 may transmit and receive signals to and from other devices outside the system 1100 according to various communication protocols. The communication device 1143 may be implemented so as to include an antenna, a transceiver, a modem, or a combination thereof.

The display 1144 may serve as an output device that outputs visual information to the user of the system 1100.

The power supply 1145 may appropriately convert power that is supplied from a battery (not shown in the drawing) included in the system 1100 or an external power source, and supply it to individual components of the system 1100.

The interface module 1146 may provide a connection between the system 1100 and an external device that can be coupled to the system 1100 so as to be able to exchange data with the system 1100. The interface module 1146 may be implemented in various interface schemes such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, universal serial bus (USB), secure digital (SD) card, multi-media card (MMC), eMMC, UFS, embedded universal flash storage (eUFS), compact flash (CF) card interface, NVMe management interface (NVMe-MI), etc.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

While the present inventions have been described in connection with what is presently considered to be practical example embodiments, it is to be understood that the inventions are not limited to the disclosed embodiments. On the contrary, it is intended to cover various modifications and equivalent arrangements included within the spirit and scope of the appended claims.

What is claimed is:

1. A multi-core processor which includes a plurality of cores, comprising:
a first core configured to
receive a task migration instruction, and
transmit metadata including branch prediction data obtained during execution of a migration subject task determined as a subject of the task migration instruction among a plurality of tasks, to an external memory; and
a second core that configure to
receive a task execution instruction,
read the metadata from the external memory based on the task execution instruction, and
execute the migration subject task using the metadata.

2. The multi-core processor of claim 1, further comprising:
a scheduler configured to
assign the plurality of tasks to the first core,
determine task migration from the first core to the second core based on utilizations of the first core and of the second core, and
transmit the task migration instruction and the task execution instruction based on the determination of the task migration from the first core to the second core.

3. The multi-core processor of claim 2, wherein
the utilization is determined based on a load or power consumption of the plurality of cores, and the utilization of the second core is less than the utilization of the first core.

4. The multi-core processor of claim 2, wherein
the multi-core processor further includes a third core configured to execute a plurality of tasks, and
the scheduler is configured to determine task migration from the third core to the first core based on the utilization of the first core and a utilization of the third core, and
the first core is configured to read metadata to be used to execute a migration subject task migrated from the third core, from the external memory.

5. The multi-core processor of claim 1, wherein
the metadata contains a tag for identifying the metadata.

6. The multi-core processor of claim 5, wherein
the task execution instruction contains a task ID for identifying the migration subject task and tag information for identifying the metadata.

7. The multi-core processor of claim 1, wherein
the first core and the second core are a same type of cores.

8. The multi-core processor of claim 1, wherein
the first core includes a first converter configured to convert the metadata according to conversion rules, and
the second core includes a second converter configured to interpret the converted metadata and reconvert the converted metadata into a form usable in the second core, according to the conversion rules.

9. The multi-core processor of claim 8, wherein
the first core and the second core are different types of cores.

10. The multi-core processor of claim 1, wherein
the metadata further contains translation lookaside buffer data (TLB data), prefetch data, and power control data.

11. The multi-core processor of claim 1, wherein
the task migration is a process migration or a thread migration.

12. An operating method of a computing system, the method comprising:
determining a first core as a source core among a plurality of cores based on a utilization of the first core;
determining a first task among a plurality of tasks assigned to the first core, as a migration subject task;
converting metadata obtained during execution of the first task into conversion data based on conversion rules; and
transmitting the conversion data to a memory.

13. The operating method of the computing system according to claim 12, further comprising:
determining a second core among the plurality of cores as a target core based on a utilization of the second core;
receiving the conversion data from the memory;
interpreting the conversion data, and reconverting the conversion data in a form usable in the target core according to conversion rules; and
executing the first task.

14. The operating method of the computing system according to claim 13, further comprising:
assigning the plurality of tasks to the plurality of cores; and
detecting utilizations of each of the plurality of cores.

15. The operating method of the computing system according to claim 14, wherein
determining the first core as the source core includes determining that the utilization of the first core exceeds a utilization threshold, and
determining the second core as the target core includes determining that the utilization of the second core is less than the utilization of the first core.

16. The operating method of the computing system according to claim 13, wherein
the metadata contains branch prediction data, TLB data, prefetch data, and power control data.

17. A multi-core processor comprising:
a scheduler; and
a first core that includes
first metadata save logics configured to
save first metadata obtained during execution of a first task that is a subject of a task migration instruction of the scheduler based on receiving the task migration instruction and
transmit the first metadata to an external memory, and
first metadata restore logics configured to
receive second metadata to be used to execute a second task that is the subject of a task execution instruction of the scheduler, from the external memory based on receiving the task execution instruction, and
restore the second metadata.

18. The multi-core processor of claim 17, further comprising:
a second core that includes second metadata restore logics configured to receive the first metadata to be used to execute the first task, from the external memory, based on a task execution instruction of the scheduler, and restore the first metadata.

19. The multi-core processor of claim 17, wherein
the scheduler is configured to transmit the task migration instruction and the task execution instruction based on a utilization of the first core.

20. The multi-core processor of claim 17, further comprising:
the first core further includes architectural logics configured to transmit information indicating a point at which the execution of the first task was stopped, to the external memory, based on the task migration instruction of the scheduler.
